(19) United States
(12) Patent Application Publication
(10) Pub. No.: US 2009/0323995 A1
(43) Pub. Date: Dec. 31, 2009

(54) Miniature Planar Acoustic Networks

(76) Inventor: Alastair Sibbald, Berkshire (GB)

Correspondence Address: DICKSTEIN SHAPIRO LLP, 1825 EYE STREET NW, Washington, DC, 20006-5403, US

(21) Appl. No.: 11/920,754

(22) PCT Filed: May 16, 2006
(86) PCT No.: PCT/GB2006/001796

§ 371 Date: Aug. 27, 2009

(30) Foreign Application Priority Data
May 21, 2005 (GB) 0510438.5

(51) Int. Cl. H04R 1/20

(52) U.S. Cl. 381/337

(57) ABSTRACT

A miniature acoustic network comprises a substantially planar member (5) having an acoustic device (9; 10, 11) indented into a major surface thereof and configured to co-operate with another acoustic device (3, 6) formed, at least in part, within the planar member to form the acoustic network. Another member (7) is juxtaposed with the surface of the planar member (5) and forms a closure for the network. In one embodiment, the other acoustic device comprises a flared conduit (3, 6) having a relatively narrow inner end disposed to overlie the diaphragm (2) of a microspeaker (1) and a relatively wide outer end opening at an acoustic outlet, and the acoustic device comprises a resonator (9) made up of a channel (10), which communicates directly with the smaller end of the conduit (3), and a circular rebate (11) communicating with the channel (10). Whereas the conduit (3) completely perforates the planar member (5), the components (10, 11) forming the resonator (9) are merely impressed or otherwise indented into the surface of the planar member (5) and are thus wholly contained within its thickness.

The present invention relates to miniature acoustic systems, especially suitable for application in personal mobile devices, such as earphones, in-ear earphones, headphones, cellular phone handsets, personal stereo players and the like. In particular, the invention relates to acoustic systems which are small enough to be considered to behave as “lumped element” systems. This condition prevails when the dimensions of an acoustic device or component are substantially smaller than the wavelength of sound being processed or operated on by the acoustic system.

Miniature acoustic systems of necessity must be manufactured to fine tolerances and, particularly when intended for use in mass produced items such as those mentioned above, they must be reliably reproducible with high accuracy, to ensure the true replication of finely tuned components. They must also be rugged and reliable in long-term usage and yet be relatively inexpensive to produce. Difficulties arise in meeting these exacting requirements, and it is an object of the invention to provide miniature acoustic systems, and methods for their manufacture, in which at least one of those difficulties is alleviated.

According to the invention from one aspect, there is provided a miniature acoustic network comprising a first substantially planar member bearing indented into a first major surface thereof at least one acoustic device configured to co-operate with at least one further acoustic device formed at least in part within said first member to form said acoustic network, and a second member juxtaposed with said first major surface of the first member and forming a closure for the acoustic structure of said network.

In some preferred embodiments, the second member is substantially planar and both of its major surfaces are substantially flat, but it may alternatively comprise other forms, such as a flat surface facing the said first surface of the first member and a profiled, sculpted or otherwise shaped, contoured or configured surface facing away from the first member.

In some preferred embodiments of the invention, the said first member bears at least one said further acoustic device as one or more apertures formed therethrough. Where apertures are used, it is preferred that a third member is juxtaposed with the first member, disposed adjacent the opposite major surface thereof to said first surface, to form a second closure for said further device.

It will thus be appreciated that, in general, the invention provides a miniature acoustic system, bearing an acoustic network, implemented as a substantially planar structure. By “substantially planar”, it is recognised that the individual acoustic component devices must possess finite thickness (say 1 or 2 mm in thickness), in order to function but the essence of the invention is that two or more acoustic devices, together constituting a network, are fabricated so as to lie in a single, thin plane within (or upon) a substrate member. For example, the acoustic network can be designed and cut, etched or otherwise indented or impressed into a surface of a single, thin (say <2 mm) sheet of metal, using a series of apertures and vias extending along the plane to create a network-carrying substrate layer, which is then capped with a blanking plate member. The preferred materials for fabrication include metals and plastics, but the invention is not restricted to these. Moreover, in any given system, the individual members may be of the same, similar or differing materials. For example, the substrate member may be of metal and the closure member may be of plastic; or vice-versa.

The term “network” as used herein is intended, in its simplest form, to define a combination of two or more acoustic devices connected together so as to perform an acoustic transformation between an input node, terminal or port, and an output node, terminal or port. Here, the term “acoustic devices” includes both passive elements, such as acoustic inertance, acoustic compliance and acoustic resistance, and also active devices, such as microspeakers and microphones.

Such planar acoustic networks are capable of performing useful acoustic signal-processing operations such as high-pass, low-pass and band-pass filtering, tuned circuits for selective absorption, optimised transmission conduits and emission ports, and orthogonal “plane-changing” functions.

Furthermore, the number of inlet and outlet ports is not restricted to one of each, and it is sometimes advantageous to have more than one inlet or outlet port, as will be described in more detail hereinafter, or even a plurality of both.

The input and output node, terminal or ports can be conveniently arranged such that the longitudinal axis of any such port lies in substantially the same plane as the acoustic network. Alternatively, one or more of the ports can be arranged so that its longitudinal axis lies substantially orthogonal to the plane of the acoustic network. In some circumstances, as will be described below in more detail, it is advantageous to have one port in-plane, and another port orthogonally arranged.

Because of the intrinsically planar nature of systems in accordance with the invention, it is possible to vertically stack two or more networks together as a composite structure, and arrange for them to be acoustically inter-coupled in order to enhance the complexity of their function, or to ease the manufacture of a complex acoustical system.

In order that the invention may be clearly understood and readily carried into effect, certain embodiments thereof will now be described, by way of example only, with reference to the accompanying drawings, in which:

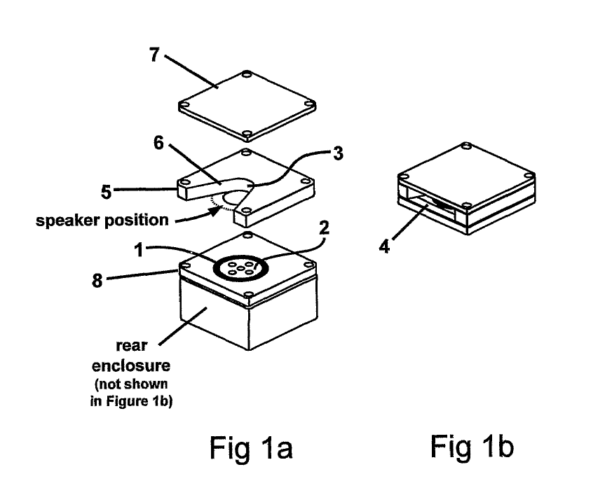

FIGS. 1a and 1b show respectively, in perspective, an exploded view of a prior acoustic device, and an assembled view of such a device;

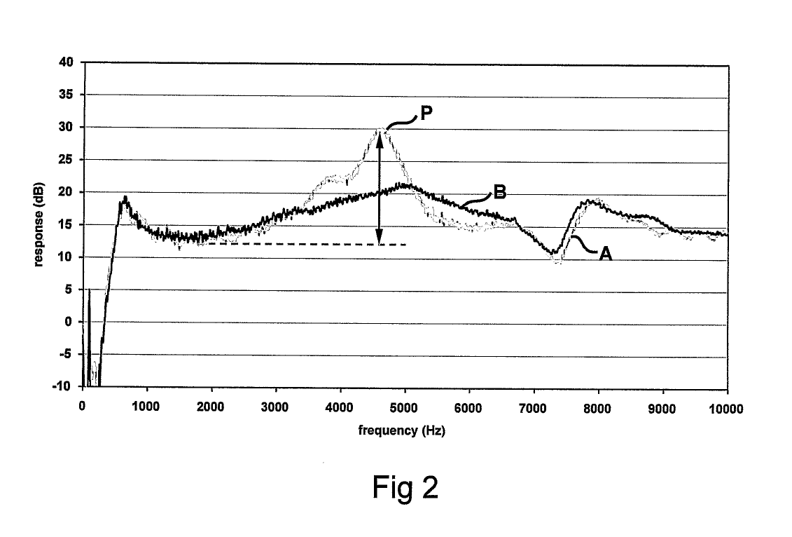

FIG. 2 shows comparative performance characteristics of a device according to FIG. 1 and such a device configured as a network in conjunction with a Helmholtz resonator;

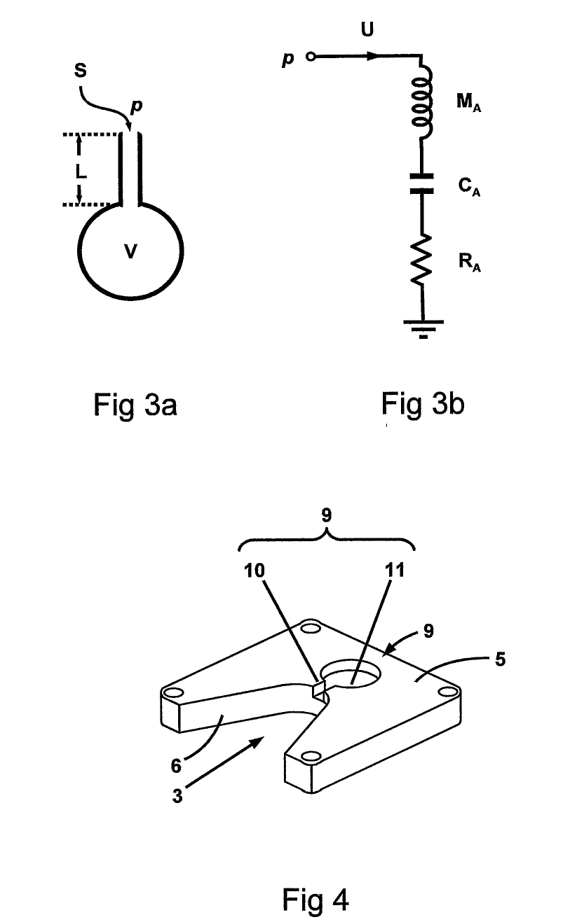

FIGS. 3a and 3b are used to explain the function of the Helmholtz resonator;

FIG. 4 shows, in perspective and exploded view, part of an acoustic network in accordance with one embodiment of the present invention;

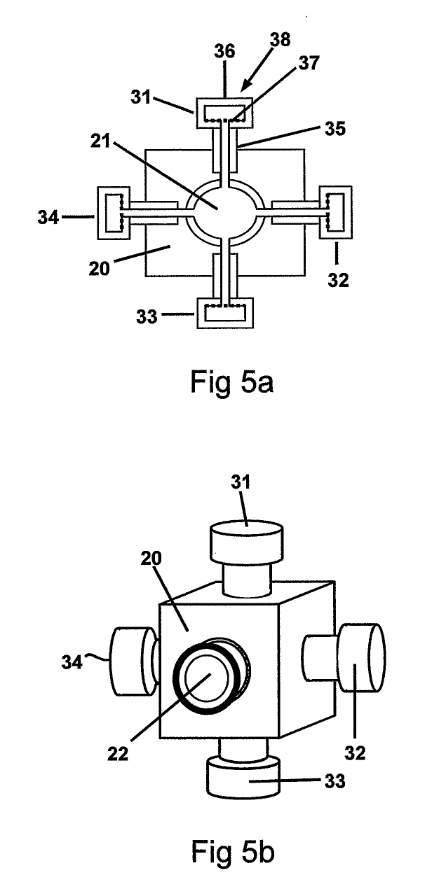

FIGS. 5a and 5b show respectively cross-sectional and perspective views of a Zwislocky coupler;

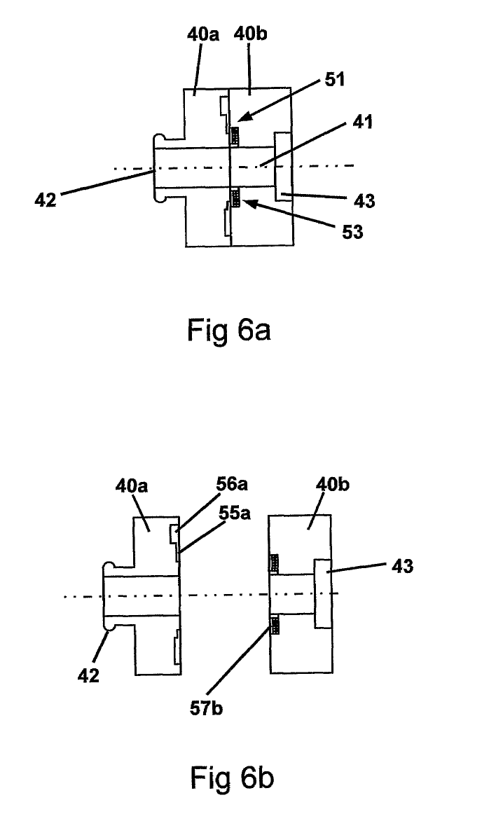

FIGS. 6a and 6b show cross-sectional views of an acoustic network in accordance with a second embodiment of the invention, configured to implement a coupler of the general kind shown in FIGS. 5a and 5b;

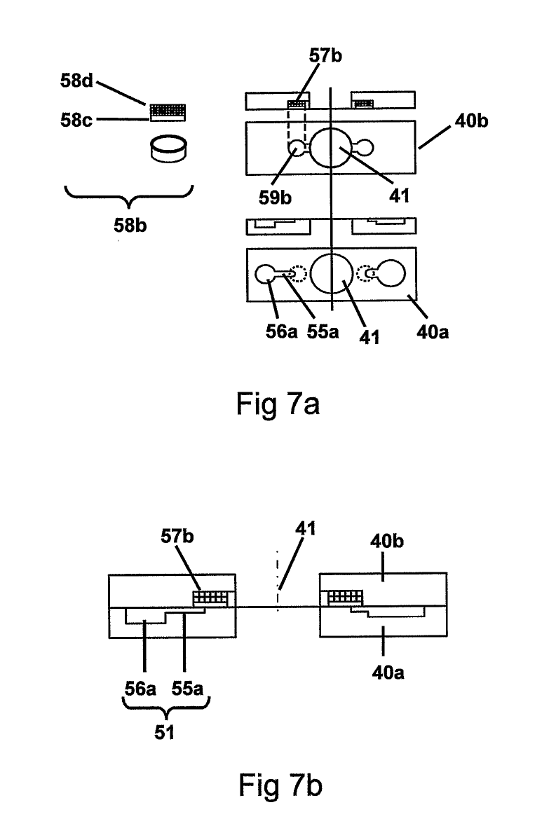

FIGS. 7a and 7b illustrate, from orthogonal perspectives, details of the network of FIGS. 6a and 6b;

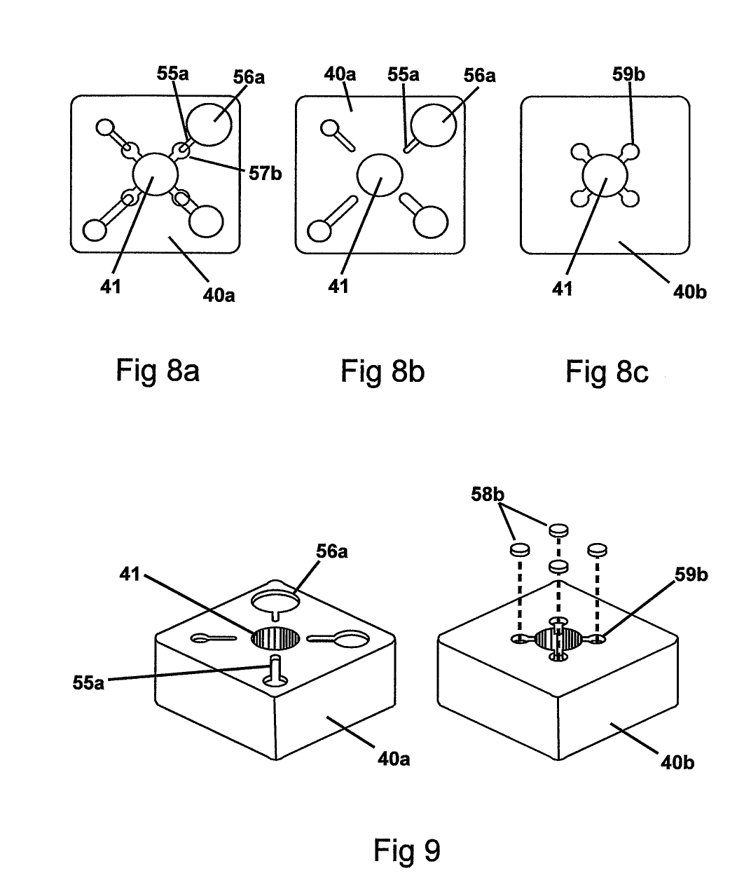

FIGS. 8a, 8b and 8c show respective plan views of the network of FIGS. 6a and 6b;

FIG. 9 shows perspective views of the surfaces of a pair of block members used to form the network of FIGS. 6a and 6b; and

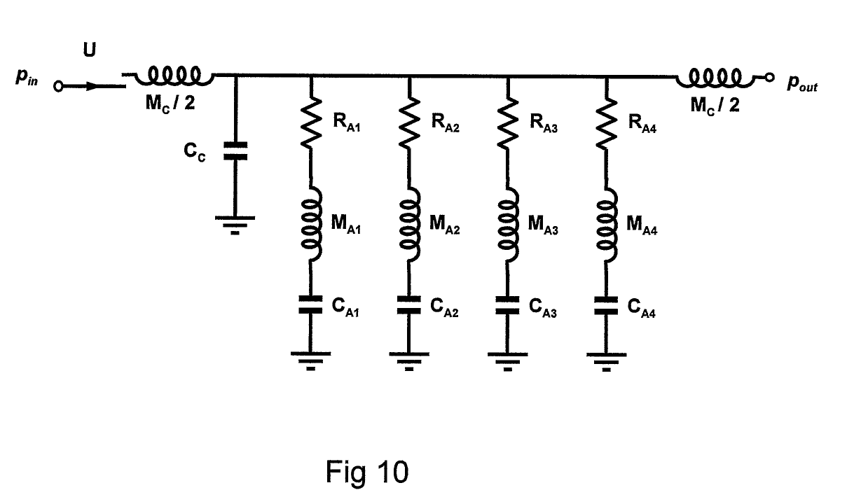

FIG. 10 shows an acoustical circuit diagram of the network.

Subsequently, reference will also be made to the following drawings in order to provide useful technological background believed to support the description of the invention, and of which:

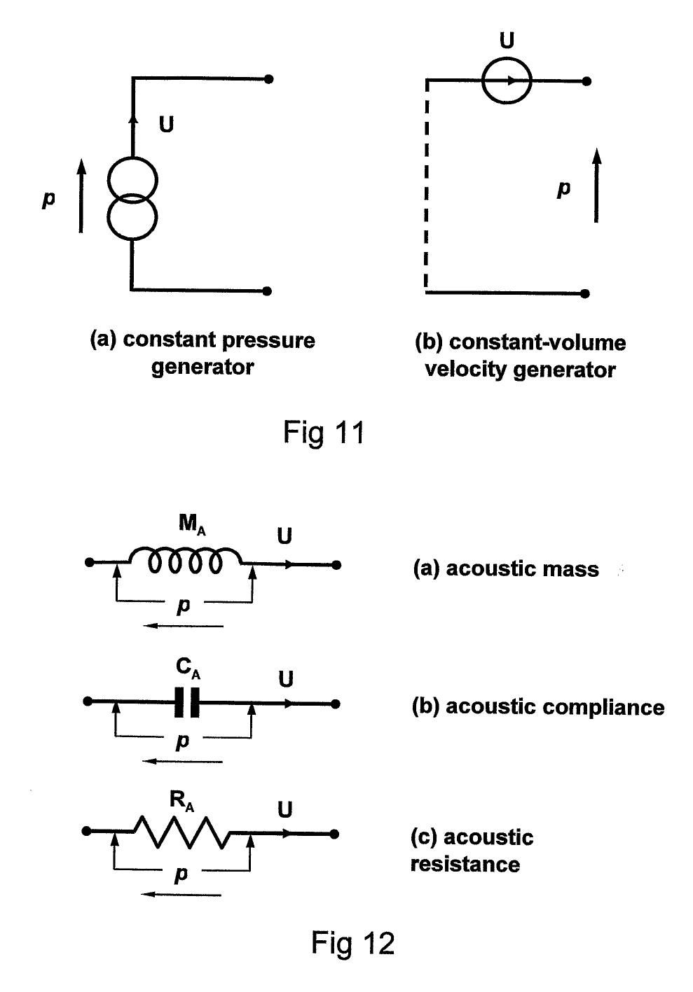

FIGS. 11a and 11b show schematic views of electrical representations of acoustic elements;

FIGS. 12a, 12b and 12c show electrical representations of certain acoustic component elements; and

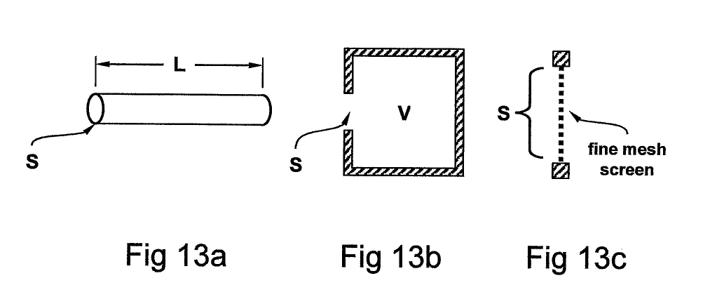

FIG. 13 shows drawings used to support descriptions of certain basic acoustic elements.

Referring first to FIG. 1, there is shown a system in accordance with a first embodiment of the invention.

In applications where space is limited, for example, in a cellular phone handset unit, it is convenient to mount a microspeaker so as to face one of the major surfaces of the phone, but to have the acoustic emission occur from the edge of the phone, as described in International Patent Application No. PCT/GB2004/004800. Referring to FIG. 1a, this can be arranged by mounting the microspeaker 1 such that the frontal area of its diaphragm 2 is coupled to thin, flat conduit 3, leading to an emission port 4 (see FIG. 1b). In the arrangement shown in FIG. 1a, the conduit 3 is formed by an “emitter plate” 5, bearing a flared aperture 6, capped by a blanking plate 7 which forms the top of the conduit 3. The base of the conduit 3 is formed by a mounting plate 8 which carries the microspeaker 1. This geometry is favourable in minimising the intrinsic resonance of the conduit 3 as described in the aforesaid international patent application. However, the conduit 3 still introduces a volume of air between the microspeaker 1 and the external air, and this possesses both inertance and compliance, which creates a significant resonance in the output conduit. Consequently, the output frequency response of the microspeaker, as shown by line A in FIG. 2, is no longer relatively flat, as it would be without the conduit, but a large, 18 dB peak P is now introduced into the spectrum at about 4.6 kHz which greatly impairs the quality of both speech and music.

A method of compensating for this unwanted resonance, described in the aforesaid international patent application and in UK Patent Application No. GB0326807.5, involves adding a compensating Helmholtz resonant absorber to the conduit, adjacent the microspeaker surface 2. Related material is also described in UK Patent Application No. GB0326806.7; all of the foregoing patent applications being assigned to the present applicant.

Referring to FIG. 3, a Helmholtz resonator comprises an enclosed volume, V, exposed to the external air via a neck having length L, and cross-sectional area S, exposed to external pressure, p (FIG. 3a), for which the analogous acoustical circuit is shown in FIG. 3b. The mass of air in the neck of the resonator acts as an acoustic mass, M_{A}, and the volume of air, V, represents an acoustic compliance, C_{A}. When the neck is a thin tube, and/or where a porous material is introduced into the volume element, then dissipative losses occur, represented by the acoustic resistance R_{A}. The Helmholtz structure represents a simple acoustic network, and the structure is characterised by its resonant frequency, ω₀ (radians/sec) as follows.

$${ω}_{0} = C \sqrt{\frac{S}{{L}^{′} V}} \qquad ( 1 )$$

Here, the factor L′ is used for the effective length of the neck, rather than the physical length, L, because of radiation-mass loading, where L′=L+1.7a for a flanged neck, and L′=L+1.5a for an un-flanged neck. In the foregoing expressions, C is the velocity of sound in air at STP and “a” is the radius of the neck opening; assumed to be circular.

Using equation (1), the dimensions of a miniature acoustic network were computed to characterise a compensating tuned circuit at about 4.6 kHz. In accordance with the first embodiment of the invention and as shown in FIG. 4, this simple network, comprising a channel 10 of 2 mm in length and 1.5 mm in depth, coupled to an 8 mm diameter circular rebate 11, also 1.5 mm in depth was formed into the surface of the orthogonal emitter plate 5 to create, with a closure member (such as that shown at 7 in FIGS. 1a and 1b) the Helmholtz resonator 9. A porous fibre acoustic resistance (not shown) was introduced into the 8 mm diameter cavity, and the emitter was re-assembled, then again appearing as in FIG. 1b. The characteristics of the orthogonal emitter both without (line A), and with (line B), the planar acoustic network in place are shown in FIG. 2, where the benefits are clear. With the planar acoustic network in place, the 18 dB peak has been substantially reduced and the frequency response is relatively flat.

It will be observed in relation to FIG. 4 that the channel 10 of the resonator 9 communicates directly with the inner (smaller) end of the conduit 3, which overlies the diaphragm 2 of the microspeaker 1 but that, whereas the conduit 3 completely perforates the emitter plate 5, the components forming the resonator device 9 are merely impressed or otherwise indented into the surface of the plate 5 and the channel 10 and rebate 11 are wholly contained within the thickness of the plate 5.

The acoustic network comprising, on the one hand, the conduit 3 and the flared aperture 6, and, on the other hand, the channel 10 and rebated cavity 11 of the resonator 9 is configured to extend substantially in the plane of the plate 5, which may be made of metal, of plastics or any other convenient material. In this example, the axis of the inlet port (i.e. that of the microspeaker 1) is orthogonal to the plane of the network and the axis of the outlet port (i.e. that of the rectangular emission aperture 4 shown in FIG. 1b) is in the plane of the network.

If desired, two or more networks in accordance with the invention can be coupled together to achieve additional functionality or to create more complex structures.

It will be appreciated that where, in connection with the invention, reference is made to acoustic devices or components being impressed or otherwise indented into the surface of a substrate, it is the intention to envisage any convenient and practical means of forming the appropriate configuration of devices or components within the substrate and open at one of its major surfaces. Thus, it is intended that techniques such as sculpting or etching, which involve removal of material from the substrate, are envisaged; as are techniques, such as moulding or pressing, which merely reconfigure substrate material in one or more selected regions thereof.

Referring now to a second embodiment of the invention, it is well known that the human auditory canal possesses complex acoustic properties, and these form part of our ability to “localise” sound in three dimensional space. It is part of a more complicated acoustic structure, coupled on its outer side via the concha cavity to the outer-ear structure (pinna), which is coupled to the ambient air. On its inner side, it is bounded by the tympanic membrane which, in turn, is coupled via the ossicies to the oval window of the cochlea. An excellent account of the structure and mechanism of the ear is contained in:
1979 Rayleigh Medal Lecture: The Elusive Connection; and External ear response and localization; E A G Shaw, Chapters 1 & 2 in Localization of Sound: Theory and Applications, R W Gatehouse (Ed.), Amphora Press, Connecticut (1982), pp. 13-29 and pp. 3041 respectively;
   from which it is clear that the properties of individual component elements of the ear cannot be measured directly. However, by constructing a lumped element parameter model which exhibits the same properties as ear, it becomes possible to synthesize physical devices which possess similar acoustical properties. One example of this is known as the “Zwislocki coupler”.

The Zwislocki coupler, described in:
Anthropometric manikin for acoustic research; M D Burkhardt and R M Sachs, J. Acoust. Soc. Am., July 1975, 58, (1), pp. 214-222,
   is a multi-port acoustic device for simulating the human auditory canal. It was developed for the evaluation of hearing-aids and their associated earphones. It features an input port, to which is connected the earphone under test, and an output port, connected to a laboratory reference-quality microphone. The device itself simulates the complex impedance of the human ear canal up to about 8 kHz, and this enables the performance of an earphone to be characterized accurately, and with repeatability, because the coupler presents the correct complex acoustic load to the earphone outlet port. This is valuable because it provides an objective measurement means with which a variety of earphones can be compared. However, the construction of the acoustic network of the Zwislocki coupler is complex, requiring four parallel, tuned resonant circuits to be coupled into a central conduit lying between the inlet and outlet ports. In addition, the very small size and fragility of the component parts (fine-bore tubing and fine metal meshes), together with the need for hand-fabrication and associated variations in assembly, requires that the various components in each fabricated coupler are individually adjusted and calibrated, using screw threads, so as to provide the requisite acoustical characteristics.

As a consequence, this form of the Zwislocki coupler does not lend itself to mass-production, and so those which are commercially available are very expensive (˜$1000).

FIG. 5 shows two diagrams of a typical Zwislocki coupler. FIG. 5a shows a simplified section though the main body, including the side-branches, and FIG. 5b is an isometric representation of the coupler, showing the relationship between the various ports.

The components are typically made from steel. Essentially, there is a main body 20 in the form of a cuboid block, through which a central cylindrical cavity 21 is machined. This primary cavity 21 corresponds to the auditory canal, and therefore features similar dimensions: it is 7.5 mm in diameter, and 21.5 mm in length. On the inlet end of this cylindrical cavity, a nipple-type extrusion 22 (see FIG. 5b) is provided to mate into a suitable artificial outer-ear moulding, made from silicon rubber. At the other end of the cylindrical cavity, there is a 12.5 mm diameter threaded inset, which cannot be seen in the Figure, with a sealing gasket, into which a reference microphone can be screwed. Hence, the microphone acts as the tympanic membrane, detecting the signals which propagate down the 21.5 mm long “auditory canal” cavity 21 after passing through the artificial outer ear moulding.

On each of the orthogonal four faces, around the longitudinal axis of the central, tube-like cavity 21, there is provided a respective side-branch device 31, 32, 33 and 34, as shown in FIG. 5a. Each side branch device (such as 31) comprises a narrow bore tube such as 35 (providing acoustic mass, or inertance), leading from the central cavity 21 to an enclosed volume such as 36 (providing acoustic compliance) machined into a side-branch “head” unit 38, via an acoustic resistance mesh such as 37 (providing acoustic resistance). The mesh 37 is locked into place between the threaded narrow bore tube 35 and the outer “head” unit 38 into which it screws. Each side branch therefore comprises of a serial inertance-resistance-compliance structure, which is a tuned, damped, resonant circuit, corresponding to a serial L-C-R circuit in electrical terms. Each of the four side branches 31 to 34 features different values for the inertance, compliance and resistance parameters, and hence is tuned to resonate at differing regions of the spectrum. The four side-branches 31 to 34, acting in combination, are claimed to mimic accurately the complex impedance of the auditory canal up to about 8 kHz.

One of the important advantages of the present invention is that it can be used to make a complicated acoustic network, such as a Zwislocki-type coupler, just as easily as a simple network, such as that shown in FIG. 4. A complex coupler can be fabricated as a planar acoustic network, according to an embodiment of the present invention and as shown by way of example in FIG. 6, by forming the various acoustic devices in a plane in the centre of a metal block 40 bearing a central conduit 41.

Some basic features of this new planar ear-coupler are necessarily similar to the original Zwislocki coupler, in that (a) the inlet port 42 must couple to an artificial ear; is (b) the outlet port 43 must couple to a 12 mm diameter reference microphone; and (c) the central conduit 41 must replicate the effective dimensions of the human ear canal (7.5 mm in diameter and 21.5 mm in length). This is achieved conveniently using a suitably sized metal or alloy block, through which a central 7.5 mm diameter conduit is formed. A short, flanged inlet extension 42 is provided at one end of the conduit, to fit into an artificial ear, and a threaded, 12 mm diameter outlet port 43 is provided to couple to a suitable laboratory reference microphone (not shown) at the other end. The metal block 40 is made from two smaller blocks 40a and 40b, as shown in FIG. 6. In this example, the blocks 40a and 40b are of similar size, and they are secured (e.g. bolted) together to form a single assembly. The total length of the resultant central conduit 41 is 21.5 mm.

The intricate and complicated acoustic side branches of the original Zwislocki coupler (FIG. 5) are implemented, in accordance with this embodiment of the invention, as a miniature acoustic network, which is formed on to the inner faces of the mating surfaces of blocks 40a and 40b, as shown in FIG. 6b. In manufacture, this is trivial and inexpensive to do. Each of the four side branches, such as 51, comprises a respective serial mass-resistance-compliance acoustic circuit. The mass and compliance network components such as 55a and 56a for these branches are formed into a surface of block 40a, and four associated resistive couplers such as 57b are formed into the mating surface of block 40b, as is shown in more detail in FIG. 7.

It will be appreciated that the acoustic circuit of each side branch such as 51 communicates with the central conduit 41 by way of the resistance element such as 57b, formed in the surface of block 40b, and that the element such as 57b is overlain by a part of the associated mass element (channel) such as 55a which further communicates with the associated compliance component (rebated cavity) such as 56a. Thus each of the acoustic devices comprised in the side branches 51 to 54 extends in a substantially common plane radially outwardly from the central conduit 41; the axes of the inlet and outlet ports being, in this example, coincident with one another and with the axis of the conduit 41, and thereby substantially orthogonal to the plane of the acoustic network incorporating the said devices.

In order to introduce a fine acoustic resistance mesh into the network by a method compatible with mass production, and then locate it securely, acoustic resistor “inserts” are used, as follows. An acoustic resistance mesh sheet (58c) is bonded on to a thin (1 to 2 mm thick) foam sheet (58d) support, and 3 mm diameter plugs such as 58b (see FIGS. 7a and 8) are punched from the composite. The foam support is an open-cell polymer, and it is acoustically transparent. The acoustic resistor plugs such as 58b are inserted into suitable rebated cavities such as 59b in block 40b, with the resistive mesh facing outwards so as to contact block 40a. The plug length is slightly longer than the depth of its cavity 59b, and thereby arranged so as to compress slightly the support foam when the two blocks 40a and 40b are secured together, thus pressing the resistive mesh in contact with block 40a, partly overlying its respective acoustic mass channel such as 55a. Hence the air in the central conduit 41 is in free and direct contact with the air in the support foam of all resistive plugs such as 58b, and thereby to the outermost face of the resistive mesh itself. As can be seen in FIG. 7b, for each of the four side-branch circuits such as 51, the air is then coupled through the mesh into an acoustic mass channel such as 55a, which leads to a volume of air such as 56a acting as an acoustic compliance. This forms the four requisite serial resistance-mass-compliance circuits coupled to the central conduit 41.

FIG. 8 shows a plan view of the four acoustic circuits in the planar network. FIG. 8a is a composite view of all components, to show the overlaps and coupling. FIG. 8b shows the central conduit, together with the differing acoustic mass channels and respective compliance volumes, and FIG. 8c shows the acoustic resistor insert positions. FIG. 9 shows an isometric projection of blocks 40a and 40b prior to their assembly to each other.

The acoustic network formed as described above features fifteen acoustic components in all, as indicated by the acoustic circuit diagram of FIG. 10. Each of the side branch resonant circuits may have differing values of R_{A}, M_{A} and C_{A}, as may be required, and the intrinsic compliance (C_{C}) and mass (M_{C}) of the central conduit 41 are represented by the parallel capacitance and the serial inductances respectively. (The conduit resistance losses are negligible.)

In practice, the assembly can be manufactured from plastic, rather than metal, and blocks 40a and 40b can be manufactured as a single, hinged entity which snaps together, thus providing a low cost method for manufacturing.

As an alternative to the use of foam-backed acoustic plugs, acoustic mesh or silk can be interposed between two layers, affording an acoustic resistance between them, dependent on the interactive area and specific acoustic resistance of the mesh.

As mentioned above, two or more planar acoustic networks can be coupled together for increased complexity of performance, or for ease of manufacture; moreover, porous material can be introduced directly within the bulk of acoustic volume elements as an alternative to the use of resistive meshes or screens made from acoustic silk, connected as “in-series” devices. Furthermore, additional acoustic devices may include elastic membrane compliances, stepped-tube transformers, horn-type transformers, and so on.

In connection with the above-described embodiments of the invention, and generally with respect to the invention, the following material is provided as technological background. It will be appreciated that such material is provided with the intention of facilitating the reader's understanding of some of the technology believed to underlie the invention, but the inclusion of said material is not intended to limit the scope of the invention or to be construed as, or suggest, any restriction upon the operation of the invention or devices or networks embodying the same, or to import any dependence of the invention upon the validity of any theory or formula quoted hereinafter.

In this connection, reference is first made to:
Fundamentals of Acoustics (3^{rd} edition); L E Kinsler, A R Frey, A B Coppens and J V Sanders; John Wiley and Sons, New York (1984): ISBN 0-471-02933-5; hereinafter called “Kinsler et al”.

Kinsler et al. refer to the above-mentioned condition, which prevails when the dimensions of an acoustic device or component are substantially smaller than the wavelength of sound being processed or operated on by the acoustic system as the “Long Wavelength Limit”. They point out in particular that the analysis of acoustic devices becomes simpler if the wavelength in the fluid is much longer than the dimensions of the device, and it is noted that, for a rigid-walled waveguide, there is a frequency below which the only propagating waveform that can exist is a plane wave travelling straight down the waveguide with phase speed cₚ=c. Consequently, propagation in such a waveguide is extremely simple to analyse if the wavelength is sufficiently long compared to the cross-sectional dimensions of the waveguide.

Kinsler et al. further note that, if the wavelength is greater than all dimensions of the device or component, further simplifications are possible. “In this limit, each acoustic variable is time varying but almost independent of distance over the dimensions of the device. Thus, spatial coordinates can be ignored in the equation of motion, and such a device behaves as if it were a harmonic oscillator with one degree of freedom. Acoustical devices in this long-wavelength limit are often termed lumped acoustic elements.”

In addition to the dimension of length, it is possible to apply this Long Wavelength Limit (LWL) criterion to acoustic devices which have non-monotonic dimensions, namely an area, or a volume, or both of these. One of the foregoing embodiments of the invention utilises a Helmholtz resonator which is defined by three critical dimensions: a length L (m), a volume V (m³), and a surface area S (m²). Here, a Helmholtz resonator that would fall into the category of a lumped acoustic element when:

L^{1/2}<<λ

S^{1/2}<<λ

and: V^{1/3}<<λ

that is, when the linear length related to each dimension is much less than a wavelength.

Taking the “voice spectrum” as a typical (though non-exclusive) range in which the present invention will be applied, this encompasses the frequency range 300 Hz to 3.4 kHz. The associated wavelengths are 1143 mm and 101 mm respectively, and so the LWL would refer to devices which are, say, less than 20% of the shortest wavelength. This defines the voice-spectrum LWL criterion to be 20 mm, and so for certain examples of the present invention, acoustical devices with length dimensions of less than 20 mm are considered to be lumped acoustical elements. The corresponding voice-band LWL criterion for surface area (S) is therefore 400 mm² (4 cm²), and for volume (V), it is 8000 mm³ (8 ml).

Although music audio extends over a greater bandwidth than voice, up to 20 kHz, it is envisaged that most applications of the invention will occur within or slightly above the voice band, and so the LWL dimensional criterion of about 20 mm, proposed above, is considered reasonable for (say) personal mobile device audio.

When acoustical devices and networks are studied and analysed, it is well-known that there are clear analogies between the mechanical, electrical and acoustical domains. It can be useful to construct theoretical models of complicated devices and systems based on electrical networks, in which the respective acoustic and mechanical parameters are depicted by their electrical analogy. For example, it is possible to create a conceptual model of a conventional, moving-coil type loudspeaker by translating its mechanical and acoustic properties into their electrical counterparts. This helps in the development of an understanding of the physical behaviour of the device, and more importantly, in the creation of mathematical models which can predict its performance with reasonable precision. There are now many software applications for electrical network emulation (such as SPICE), which enable such modelling to be readily accomplished, producing graphical plots and output of the predicted performance of the composite mechano-electro-acoustical device or system.

Equally well, if a device is purely acoustic, that is to say, without pure electrical or pure mechanical elements, it can still be advantageous to model the device in the electrical domain, partly because of the availability of very sophisticated electrical network analysis software. For example, Zwislocki has described in:
Analysis of the middle ear function. Part 1: input impedance; J Zwislocki; J. Acoust. Soc. Am., 34, (8), 1962, pp. 1514-523
   a complex acoustical network model of the middle-ear based on lumped element parameters.

### Acoustical Circuit Analogy

A probe microphone can be used to measure the (excess) sound pressure, p, at any point within a sound field, without disturbing it, in a similar way that an oscilloscope probe can be used to investigate and measure the voltage levels at any point within an electrical circuit. Here, the probe microphone measures the difference between the pressure at a specific point, and ambient (static) atmospheric pressure, which are present at the front and rear surfaces of its diaphragm, respectively.

If this appropriate analogy of sound pressure-to-voltage is used, a corresponding acoustic quantity must be employed for electric current. This is called “volume velocity”: the volume of gas displaced per second by the driving force p. This is analogous to the quantity of electric charge displaced per second by a driving voltage, V.

Based on this acousto-electric analogy, it is possible to determine further correspondences between the basic electrical circuit elements (resistance, capacitance and inductance), and their acoustical counterparts. A comprehensive description of the basic elemental components of an acoustic network, together with their mechanical and electrical counterparts, is contained in:
Acoustics (1993 edition); L L Beranek; American Institute of Physics, New York (1996), ISBN 0-88318-494-X, hereinafter called “Beranek”.

These acoustic network components are summarised below, for completeness, and to illustrate some aspects of the scope and nature of the present invention. Also, the important mathematical relationships between the physical quantities for the three principal circuit elements are summarised in Appendices A1, A2 and A3.

Beranek defines two inverse analogies for the similarity between the electrical domain and the acoustical domain. One is an “impedance-type” model, in which force corresponds to voltage, and velocity to current. The second, the inverse of this, is the “mobility-type model”, in which velocity corresponds to a voltage, and force to a current. For clarity and brevity, only the impedance-type model will be utilised herein.

### Acoustical Circuit Elements

The fundamental elements of an acoustic network comprise two types of generator, four types of circuit elements, and three generic physical quantities. The acoustical circuit analogy to that of an electrical circuit relates to the direct mathematical similarity between the flow in an acoustical circuit caused by a driving force applied across its terminals, and the current flow in an electrical circuit caused by the application of a voltage difference across its terminals. Here, the acoustical driving force is a pressure difference, and the acoustical flow is the “volume velocity”, U, within the circuit element.

The difference between mechanical quantities, and their acoustic counterparts is distinguished by the subscript “M” or “A” suffix. For example, a mechanical mass, M_{M}, having units of kilograms, is not the same as an acoustic mass, M_{A}, which has units of kilograms per metre⁴.

### Acoustic Generators

In the accompanying Figures here, the arrows point in the direction of the positive terminal or the positive flow.

1. Constant-Pressure Generator (FIG. 11a)

A constant pressure (or force) generator is an acoustical source in which the generated pressure is independent of output loading, analogous to an ideal electrical voltage source. The most common example of this type of generator is a moving coil loudspeaker, in that the diaphragm is coupled to the voice coil which is subject to a force that is directly proportional to the electric current flowing in the coil.

2. Constant-Volume Velocity Generator (FIG. 11b)

A constant-volume velocity generator is an acoustical source in which the generated volume velocity is independent of output loading, analogous to an ideal electrical current source. A flat piston moving within a cylinder represents an acoustic source of constant volume velocity, in that the displacement-related flow is independent of the output loading.

### Acoustic Circuit Elements

3. Inductance-Type Element: Acoustic Mass M_{A} (FIG. 12a)

The acoustical element that is used to represent an acoustic mass is a tube filled with gas (FIG. 13a). By considering, from first principles, the acceleration of the volume of fluid (air), having a mechanical mass m, within an open tube, which occurs when a pressure differential p is applied to its ends, it can be shown that, at steady state with angular frequency ω, then:

p=jωM_{A}U (2)

where p and U are RMS complex quantities, and M_{A} is the acoustic mass (kg·m⁻⁴). The acoustic inertance of the mass is analogous to an electrical inductance. Appendix A1 provides a more detailed account of acoustic mass.
4. Capacitance-Type Element: Acoustic Compliance C_{A} (FIG. 12b)

The acoustical element that is used to represent an acoustic compliance is an enclosed volume of gas with an opening in the enclosure that is exposed to external pressure variations (FIG. 13b). Acoustic compliance (m⁵·N⁻¹) represents the volume of air that is compressed by a net force without appreciable displacement of the centre of gravity of the of the air in the volume. (“Compression without acceleration.”) Further, it may be shown that:

$$p = \frac{U}{jω {C}_{A}} \qquad ( 3 )$$

where p and U are RMS complex quantities, and C_{A} is the acoustic compliance (m⁵·N⁻¹). The acoustic compliance of the enclosed volume is analogous to an electrical capacitance. Appendix A2 provides a more detailed account of acoustic compliance.
5. Resistance-Type Element: Acoustic Resistance R_{A} (FIG. 12c)

Acoustic resistance, analogous to its electrical counterpart, is associated with dissipative losses. These are caused by frictional (viscous) and thermal interactions between the gas and its boundaries. For example, the viscous flow of gas through a fine-mesh screen, or through a very narrow bore capillary tube generates significant dissipative losses.

The acoustical element that is used to represent an acoustic resistance is a fine-mesh screen (FIG. 13c), through which flow can occur. The dimensions of acoustic resistance are N·s·m⁻⁵ (also known as the mks acoustic ohm). Appendix A3 provides a more detailed account of acoustic resistance.

### 6. Transformation-Type Element

There are some particular pure acoustic arrangements which can be modelled by means of an acoustic transformer element (for example, when there is a sudden discontinuity in the diameter of a pipe). However, the transformer-type circuit element is probably most widely used when modelling devices with attributes in more than one of the electrical, mechanical and acoustic domains. This relates largely to electromechanical transducers, and especially to the moving coil loudspeaker. Transformer-type circuit elements provide an elegant and convenient method of integrating electrical circuit components (driving current and voice coil) to the subsequent mechanical circuit elements, and then, in turn, to the acoustical circuit components.

### Physical Quantities

7. Pressure Drop Across the Circuit Element: p (N·m⁻²)

In the same way that a voltage is the driving force in an electrical circuit, then pressure is the driving force in an acoustic one, having units of N·m². Pressure can be defined either as a differential pressure, between two specified points in space, or it can be defined with respect to the ambient (static) pressure, P₀ (10⁵ N·m⁻²), when it is often referred to as “excess” pressure.

8. Volume Velocity Flow Through the Circuit Element: U (m³·s⁻¹)

The acoustic quantity which corresponds to electric current flow is volume velocity: the volume of gas displaced, per second, by the driving pressure p. This is analogous to the quantity of electric charge displaced per second by a driving voltage, V.

### 9. Magnitude of the Circuit Element

The absolute magnitude of a circuit element relates to the physical dimensions of the acoustic components, and to their associated properties. Appendices A1, A2 and A3 describe how the magnitudes of the primary circuit elements are derived and can be calculated in practical application.

Based on the acoustic resistance dimension that one mks acoustic ohm is equal to 1N·s·m⁻⁵, and one acoustic ampere represents a volume velocity of 1 m³·s⁻¹, then from equation A3.5, one acoustic volt corresponds to a pressure of 1 N·m⁻². However, it is often convenient to use CGS units for electrical analogous circuits, in order to yield manageable component values from a miniature acoustic network.

### Appendices: A1, A2 and A3

### A1: Acoustic Mass, M_{A}

Acoustic Mass M_{A} is analogous to (Mechanical) Mass M_{M}, but has the dimensions kg·m⁴. It is associated with a mass of gas which undergoes acceleration by a net force, without compression. The relationship between pressure, acoustic mass, and volume velocity can be derived from first principles by considering the action of a pressure difference, p (N·m⁻²), across the ends of a tube having cross sectional area S, and length L (FIG. 13a).

The pressure difference, p, results in a net force, f, acting on the (mechanical) mass of gas in the tube, M_{M}. According to Newton's second law, the mass is accelerated, thus causing a change in the its linear velocity, u.

$$f ( t ) = {M}_{M} \cdot \frac{d u ( t )}{d t} \qquad ( A1 .1 )$$

This mechanical relationship can be expressed in acoustical terms by converting the applied force variable, f, into pressure difference p, by dividing throughout by the cross-sectional area, S, of the tube.

$$\frac{f ( t )}{S} = \frac{{M}_{M}}{S} \cdot \frac{d [ u ( t ) S ]}{d t \cdot S} \qquad ( A1 .2 )$$

The net force f applied over the area S represents the pressure difference, p, across the tube [p(t)=f(t)/S], and hence:

$$p ( t ) = \frac{{M}_{M}}{{S}^{2}} \cdot \frac{d [ u ( t ) S ]}{d t} \qquad ( A1 .3 )$$

Also, the product of the linear velocity, u (m·s⁻¹) and the cross sectional area, S, represents the instantaneous volume velocity, U (m³·s⁻¹), and so A1.3 simplifies to:

$$p ( t ) = \frac{{M}_{M}}{{S}^{2}} \cdot \frac{d U ( t )}{d t} \qquad ( A1 .4 )$$

Acoustical equation A1.4 is of similar form to that of its mechanical counterpart, A1.1. It can be made directly comparable by defining the

$$\frac{{M}_{M}}{{S}^{2}}$$

term in A1.4 to be the acoustic mass, M_{A}, and hence:

$$p ( t ) = {M}_{A} \cdot \frac{d U ( t )}{d t} \qquad ( A1 .5 )$$

This relationship describes the rate of change of volume velocity, U (m³·s⁻¹), of an acoustic mass M_{A} (kg·m⁻⁴), owing to an instantaneous applied pressure difference p (N·m⁻²) between the ends of the mass M_{M} undergoing acceleration.

Acoustic mass (or, more descriptively, “acoustic inertance”), is therefore analogous to electrical inductance, and, in practical application to a physical system, is most conveniently calculated using its relationship to mechanical mass, as in A1.6.

$${M}_{A} = \frac{{M}_{M}}{{S}^{2}} kg \cdot {m}^{- 4} \qquad ( A1 .6 )$$

### A2: Acoustic Compliance, C_{A}

Acoustic Compliance C_{A} is analogous to (Mechanical) Compliance C_{M} (m·N⁻¹) but has the dimensions m⁵·N⁻¹. It is associated with a volume of air that undergoes compression by a net force, without significant displacement of its centre of gravity.

The relationship between pressure, acoustic compliance and volume velocity can be derived by considering the action of the instantaneous pressure, p, applied to the opening (surface area S) of an enclosed volume, V, containing a mass of air (FIG. 13b).

The mechanical analogy is that of a spring, with one end fixed, undergoing compression by the application of a force, f, such that the moving end of the spring has instantaneous velocity u. At any point in time, the linear displacement of the moving end of the spring is equal to the integral of its instantaneous velocity, u, with respect to time. The mechanical compliance, C_{M}, which is the displacement per unit applied force, is therefore:

$${C}_{M} = \frac{\int u ( t ) \cdot d t}{f ( t )} \qquad ( A2 .1 )$$

and hence:

$$f ( t ) = \frac{1}{{C}_{M}} \int u ( t ) \cdot d t \qquad ( A2 .2 )$$

Again, as in the previous section, this mechanical representation can be converted to an acoustical one by converting the applied force variable, f, into instantaneous pressure p (which is acting to compress the volume of air), by dividing throughout by the cross-sectional area, S, of the opening.

$$\frac{f ( t )}{S} = \frac{1}{{C}_{M} \cdot S} \int \frac{u ( t ) \cdot S}{S} \cdot d t \qquad ( A2 .3 )$$

The net force f applied over the area S represents the pressure difference, p, across the tube [p(t)=f(t)/S], and hence:

$$p ( t ) = \frac{1}{{C}_{M} \cdot S} \int \frac{u ( t ) \cdot S}{S} \cdot d t \qquad ( A2 .4 )$$

Again, the product of the linear velocity, u (m·s⁻¹) and the cross sectional area, S, represents the instantaneous volume velocity, U (m³·s⁻¹), and so A2.4 simplifies to:

$$p ( t ) = \frac{1}{{C}_{M} {S}^{2}} \int U ( t ) \cdot d t \qquad ( A2 .5 )$$

Acoustical equation A2.5 is of similar form to that of its mechanical counterpart, A2.2. It can be made directly comparable by defining the C_{M}S² term in A2.5 to be the acoustic compliance, C_{A}, and hence:

$$p ( t ) = \frac{1}{{C}_{A}} \int U ( t ) \cdot d t \qquad ( A2 .6 )$$

This relationship describes the change in compression of an enclosed volume of air, having acoustic compliance C_{A} (m⁵·N⁻¹), owing to applied pressure p (N·m⁻²) generating a volume velocity U (m³·s⁻¹).

Acoustic compliance is therefore analogous to electrical capacitance. In practical application to a physical system, it is most conveniently calculated using its relationship to volume, as in A2.7:

$${C}_{A} = \frac{V}{γ \cdot {P}_{0}} {m}^{5} \cdot {N}^{- 1} \qquad ( A2 .7 )$$

where γ is the adiabatic ratio of the specific heat capacities of air (˜1.4 for a diatomic gas at STP), and P₀ is the static pressure (10⁵ N·m⁻²).

### A3: Acoustic Resistance, R_{A}

Acoustic Resistance R_{A}, analogous to its electrical and mechanical counterparts, is associated with dissipative losses. These are caused by frictional (viscous) and thermal interactions between the gas and its boundaries. For example, the viscous flow of gas through a fine-mesh screen, or through a very narrow bore capillary tube, generates significant dissipative losses. It is a constant quantity, having dimensions of N·s·m⁻⁵ (also known as the mks acoustic ohm).

The acoustical element that is used to represent an acoustic resistance is a fine-mesh screen, through which flow can occur, having a surface area of S m² (FIG. 13c). (In practise, such screens are often made from sintered metal or acoustic silk.)

In a mechanical system, the mechanical resistance R_{M} represents the constant of proportionality between the linear velocity, u, and the applied force f. The resistance R_{M} is the force per unit velocity that is required to maintain a constant velocity.

f(t)=R_{M}·u(t) (A3.1)

Again, this mechanical representation can be converted to an acoustical one by is converting the applied force variable, f, into instantaneous pressure p (which acts so as to maintain constant volume velocity through the acoustic resistance), by dividing throughout by the cross-sectional area, S, of the resistive mesh.

$$\frac{f ( t )}{S} = \frac{{R}_{M}}{S} [ \frac{u ( t ) \cdot S}{S} ] \qquad ( A3 .2 )$$

The net force f applied to the area S represents the pressure difference, p, across the resistive mesh [p(t)=f(t)/S], and hence:

$$p ( t ) = \frac{{R}_{M}}{S} [ \frac{u ( t ) \cdot S}{S} ] \qquad ( A3 .3 )$$

Again, the product of the linear velocity, u (m·s⁻) and the cross sectional area, S, represents the instantaneous volume velocity, U (m³·s⁻¹), and so A3.3 simplifies to:

$$p ( t ) = \frac{{R}_{M}}{{S}^{2}} \cdot U ( t ) \qquad ( A3 .4 )$$

And again, acoustical equation A3.4 is of similar form to that of its mechanical counterpart, A3.1, to which it can be made directly comparable by defining the

$$\frac{{R}_{M}}{{S}^{2}}$$

term in A3.4 to be the acoustic resistance, R_{A}, and hence:

p(t)=R_{A}·U(t) (A3.5)

This relationship describes the volume velocity U (m³·s⁻¹) which flows through an acoustic resistance, R_{A} (N·s·m⁻⁵) as the result of a pressure difference (N·m⁻²) applied across the resistance.

Acoustic resistance is therefore analogous to electrical resistance. In practice, fine-mesh screens, small-bore tubes, narrow slits and porous materials can be used to create an acoustic resistance. For meshes (and porous materials), the acoustic resistance cannot be computed directly from physical parameters, but it can be calculated from manufacturers' Specific Acoustic Resistance (Rₛ) data (obtained by measurement), by dividing Rₛ by the area of the screen. For example, a fine mesh having 40 wires per linear cm, with a wire diameter of 0.0115 cm, has an Rₛ value of about 9.1 mks rayls (N·s·m⁻³), and so a 5 mm diameter opening (area=19.6 mm²) via a layer of this mesh would have an acoustic resistance of 464(10⁶) N·s·m⁻⁵.

1. A miniature acoustic network comprising a first substantially planar member bearing indented into a first major surface thereof at least one acoustic device configured to co-operate with at least one further acoustic device formed at least in part within said first member to form said acoustic network, and a second member juxtaposed with said first major surface of the first member and forming a closure for the acoustic structure of said network.

2. A network according to claim 1, wherein the second member is substantially planar and both of its major surfaces are substantially flat.

3. A network according to claim 1, wherein the second member comprises a flat surface facing the said first surface of the first member and a profiled, sculpted or otherwise shaped, contoured or configured surface facing away from the first member.

4. A network according to claim 1, wherein the said first member bears at least one said further acoustic device as one or more apertures formed therethrough.

5. A network according to claim 4, wherein a third member is juxtaposed with the first member, disposed adjacent the opposite major surface thereof to said first surface, to form a second closure for said further device.

6. A network according to claim 1, wherein the acoustic network comprises one or more devices having components cut, etched or otherwise indented or impressed into said first major surface.

7. A network according to claim 1, wherein a surface of a single, substantially planar sheet of material bears a series of apertures and vias extending substantially along the plane to create a network-carrying substrate layer, which is capped with a plate-like closure member.

8. A network according to claim 1, wherein said substantially planar member is fabricated of metal.

9. A network according to claim 1, wherein said substantially planar member is fabricated of plastics.

10. A network according to claim 1 wherein said second member is fabricated of metal.

11. A network according to claim 1, wherein said second member is fabricated of plastics.

12. A network according to claim 1, having at least one input or output port disposed with an axis substantially coincident with said substantially planar member.

13. A network according to claim 1 having at least one input or output port disposed with an axis substantially orthogonal to said substantially planar member.

14. A network according to claim 1, wherein said at least one acoustic device comprises a resonator and said at least one further acoustic device comprises a conduit flaring from a relatively narrow dimension to a relatively wide dimension; said conduit at its widest dimension comprising an output port substantially aligned with the plane of said network and at its narrower dimension providing an input port substantially orthogonal to the plane of said network.

15. A network according to claim 14, further comprising a microspeaker is coupled to said input port, and wherein said conduit device and said resonator are configured and dimensioned to impart a predetermined audio characteristic to acoustic signals generated by the microspeaker and emitted from said output port.

16. A network according to claim 1, configured as a Zwislocky-type coupler, comprising a block member with said substantially planar member disposed substantially orthogonally to a tubular conduit running therethrough.

17. A network according to claim 16, wherein said block member is formed of two facing portions, and wherein said network comprises a plurality of components, each containing at least one element formed within each of said facing surfaces.

18. A network according to claim 1, wherein at least one said acoustic device includes a cavity impressed into or otherwise provided in said first member, and wherein an acoustic resistance is provided by means of a plug comprising acoustic resistance mesh sheet bonded on to a thin foam support; the plug being shaped to substantially fit the cavity.

19. A network according to claim 18, wherein said plug is cut or punched from a sheet comprising a laminate of said acoustic resistance mesh sheet and said foam.

20. A system according to claim 18, wherein said foam support is an acoustically transparent open-cell polymer.

21. A plurality of networks according to claim 1, stacked with their substantially planar members in substantial alignment to form a vertical structure; the networks being acoustically inter-coupled.

22. A personal mobile device, such as a pair of earphones, in-ear earphones, or headphones; a cellular phone handset, or a personal stereo player, including a network according to claim 1.

23. A personal mobile device, such as a pair of earphones, in-ear earphones, or headphones; a cellular phone handset, or a personal stereo player, including a stacked plurality of networks according to claim 21.
